(19) United States
(12) Patent Application Publication
(10) Pub. No.: US 2013/0052748 A1
(43) Pub. Date: Feb. 28, 2013

(54) ASSAY DEVICE AND METHOD OF ASSAYING

(71) Applicants: Neil J. Campbell, Damascus, MD (US); Keith Edward Moravick, Mountain View, CA (US); Bruce J. Richardson, Los Gatos, CA (US)

(72) Inventors: Neil J. Campbell, Damascus, MD (US); Keith Edward Moravick, Mountain View, CA (US); Bruce J. Richardson, Los Gatos, CA (US)

(73) Assignee: Supernova Diagnostics, Inc., Germantown, MD (US)

(21) Appl. No.: 13/221,381

(22) Filed: Aug. 30, 2011

(51) Int. Cl. G01N 21/64; G01N 21/75

(52) U.S. Cl. 436/501; 422/69

(57) ABSTRACT

A device for testing an analyte comprises a pathway allowing passage of analyte from an application zone to a waste zone. The device includes label material that emits or modifies light and which binds to the analyte. Between the application and waste zones there is a capture zone having capture material for binding any analyte traversing the pathway to the pathway. A first optical filter on one surface of the device allows transmission of light emitted or modified by the label and blocks light of at least one other wavelength range. This enables the device to be illuminated from one surface and light emitted or modified by the label to be detected from the opposite surface. The device may include a second filter allowing shorter wavelength light to reach the label. The device may be viewed using an illuminating reader or held up to a light source for viewing.

### BACKGROUND OF THE INVENTION

This invention relates generally to devices for bio-assay, pathogen, or molecular analysis, and to systems and methods for such analysis. The invention may be employed for bio-assays such as sandwich or competitive assays, e.g. immunoassays, for example fluorescence immunoassays (FIA).

Optical systems may be used to determine the presence, concentration or quantity of an analyte in a test sample, quantitatively, semi-quantitatively or qualitatively. However, while such systems may be used successfully, they suffer from a number of disadvantages. For example, they may require the use of relatively expensive equipment in order to perform the assay which may not be appropriate for some determinations or may not be available for some tests. For example, in some cases a qualitative determination of the presence of an analyte may be sufficient whereas in other cases a quantitative determination may be necessary. Furthermore, such tests may be of limited performance leading to tests having to be repeated. In addition, there is a general desire to reduce the cost of the equipment used for the assay, and to reduce the time taken to perform the test. In other cases, it may not be desired to perform such an assay under laboratory conditions but instead it may be necessary to perform the test in the field with the minimum of equipment.

### SUMMARY OF THE INVENTION

According to one embodiment, the present invention provides an assay device for enabling a test to be performed on an analyte. The device may have an application zone for receiving a quantity of the analyte, a waste zone, and a pathway for allowing passage of the analyte from the application zone to the waste zone. In one embodiment the device includes a quantity of a label material which will emit or modify light at least when activated and which will bind to the analyte. The pathway may also include a capture zone located between the application zone and the waste zone that has a quantity of capture material which is bound to the pathway and which will bind to any analyte that passes along the pathway so that the analyte will be bound to the pathway. The device has a first optical filter on a side thereof for allowing transmission of light emitted or modified by the label material and for blocking light of at least one other wavelength range in order to enable the device to be illuminated from one side thereof and for light emitted or modified by the label material located in the pathway to be detected from the opposite side thereof.

The device may be employed for performing lateral flow tests or other forms of test such as flow-through devices and tests and microfluidic tests, indeed for any test that may be used for competitive or sandwich assays.

This form of device may be employed in a number of ways. For example, it may be used together with an illumination and reading device in order to detect very small quantities of the analyte, or to perform quantitative tests on the analyte. However, in other circumstances it may be employed without a reader in order to perform a less sensitive or qualitative test simply to determine the presence or absence of an analyte.

According to another embodiment, the invention provides an arrangement that comprises the assay device in conjunction with a reader for detecting an output from the device when it is illuminated with light. The reader may comprise a light source and power source for the light source (or terminals for connection to a power source) for illuminating one surface of the assay device, and an optical detector for detecting light emitted by the device.

According to yet another embodiment, the invention provides a method of performing an assay, for example a lateral flow test, which comprises applying a quantity of analyte to the test device, causing the analyte to pass along the device so that it will be bound to the pathway by the capture material, and then illuminating the device in order to detect the presence or absence of analyte or the quantity of analyte by detecting the degree to which the light is modified by the label material. Thus the method may include applying a quantity of the analyte to the application zone and allowing the analyte to pass along the pathway to and beyond a capture zone where the pathway includes a quantity of capture material which will bind the analyte to the pathway, causing the analyte to contact a quantity of a label material which will emit or modify light at least when activated and which will bind to the analyte so that the analyte and label material will be bound to the pathway at the capture zone;

applying a quantity of a wash to the application zone in order to cause excess analyte and label material to flow along the pathway to the waste zone; and

illuminating one side of the assay device and detecting light that is emitted or modified by the label material from the opposite side of the device, the said opposite side of the device including an optical filter for allowing transmission of light emitted or modified by the label material and for blocking light of at least one other wavelength so that detection of the light will indicate the presence or quantity of the analyte.

Normally, the assay device will include a label zone where a quantity of the label material is located, the label zone preferably being located on the pathway between the application zone and the capture zone, so that on application of the analyte the analyte will contact the label material, and the analyte and label material will together pass along the pathway to the capture zone. However, in the broadest aspect of the invention, it is not necessary for the label material to be located on the pathway of the device when the assay device is supplied, and it is possible for the label material to be supplied separately and be applied to the device along with the analyte.

### BRIEF DESCRIPTION OF THE DRAWINGS

The present invention will now be described by way of example with reference to the accompanying drawings, in which:

FIG. 1 is a schematic perspective view of a test device and reader according to the present invention;

FIG. 2 is a more detailed view of the test device of FIG. 1;

FIG. 3 is an exploded view of the test device shown in FIG. 2 showing the various components thereof;

FIG. 4 is a graphical representation of emission and absorption spectra of one form of label material that may be employed in the device;

FIG. 5 is a view of the device with the top surface removed to show the inner details thereof;

FIG. 6 is a schematic view of the device and reader;

FIG. 7 is a view of the device during a test according to the invention;

FIG. 8 shows the device at one point during the test; and

FIG. 9 shows the device at another point during the test.

### DETAILED DESCRIPTION OF THE INVENTION

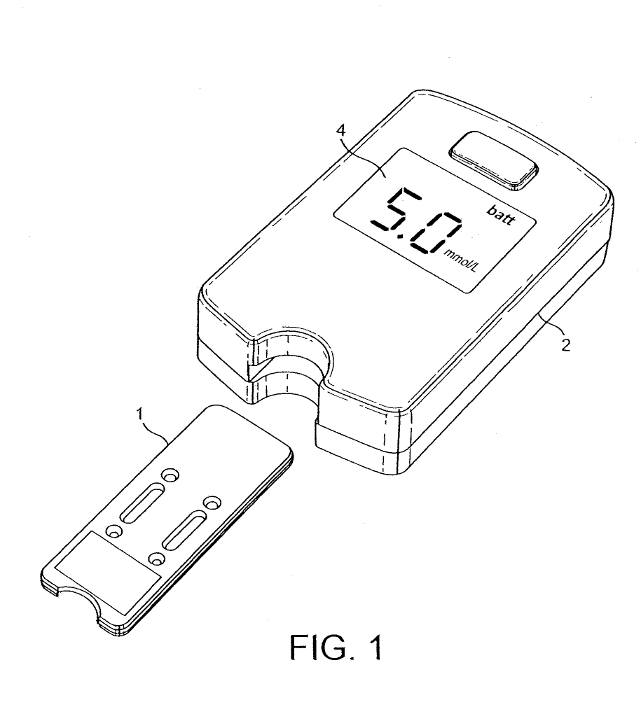

FIG. 1 shows schematically an assay device or test strip 1 and a reader 2 for enabling a quantitative or qualitative test to be performed on an analyte. In one embodiment of the invention, a quantity of an analyte may be applied to one part of the device so that it can flow along a pathway in the device toward the opposite end thereof, and the device can be inserted into the reader 2 in order to obtain an output indicative of the quantity of the analyte on the output display 4.

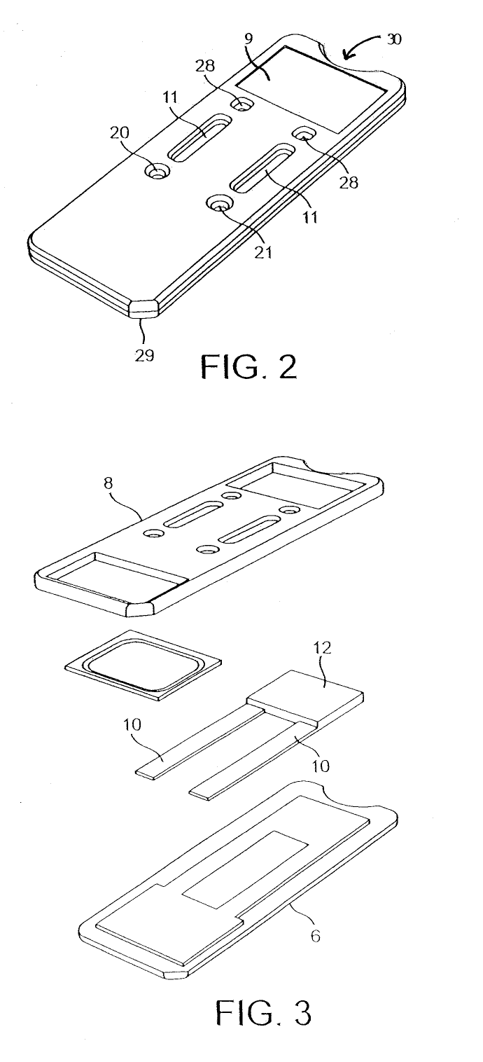

The form of the assay device is shown in more detail in FIGS. 2 and 3. As shown in FIG. 3, the device comprises a generally transparent bottom cover 6 and a generally transparent top cover 8 which is located over the bottom cover and bonded thereto. The top cover 8 may include an area 9 on which a physical label may be affixed for information. Although the top and bottom covers are usually transparent over their entire surface since this enables them to be made from a single piece of plastics material, this is not essential, and it is necessary only for the top and bottom covers to be transparent in the region of pathways 10 along which the analyte will be caused to travel. The top and bottom covers enclose a plurality of pathways 10, two in this case, one for detection of the analyte and a control pathway, although other numbers may be used if for example a number of different analytes are to be detected using the same assay device. The pathways are formed from a porous material such as nitrocellulose. The pathways 10 extend from a sample dispensing zone or application zone 14 at one end region of the device where the analyte may be dispensed during the test to the opposite end region so that the analyte will travel along the pathway during the test. In this form of assay device, the thickness of the cover may be reduced along a region 11 extending along part of the pathway 10 in order to allow the pathway to be viewed more easily. A wash collection reservoir 12 may be provided in the opposite end region of the device so that wash may be applied to the pathways to cause the analyte to flow along the pathway to the wash collection reservoir.

A quantity of a label, which as used herein includes any label precursor, may be provided at a label and primary receptor zone 16 on one or both of the pathways at a position between the sample dispensing zone and the waste zone or wash collection reservoir so that as the analyte travels along the pathway the label will be taken up by the analyte and will travel along the pathway together with the analyte. A specific bond may be formed between the label and the analyte, for example a bond between an antibody pair, an antigen pair, a DNA bond or any other bond. In one example, where the analyte is avidin, streptavidin or neutravidin, the label material may be biotinylated so that it will form a biotin-avidin bond with the analyte. The presence of the analyte may thus be detected by subsequently observing the presence of the label. The label is described in greater detail below.

Downstream of the label and primary receptor zone along the pathway is a capture zone 18 where a quantity of capture material is located. The capture material is bound to the pathway and will bind to any of the analyte that passes along the pathway so that the analyte will be retained in one position on the pathway 10 corresponding to the capture material. In the case of a device that is used to detect avidin, streptavidin or neutravidin mentioned above, the capture material may also be biotinylated so that the analyte will be bound to the pathway by a biotin-avidin bond.

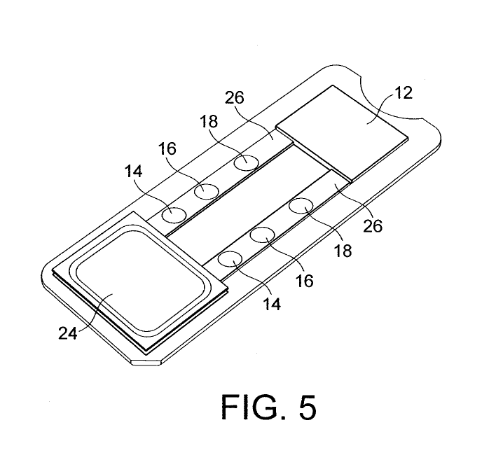

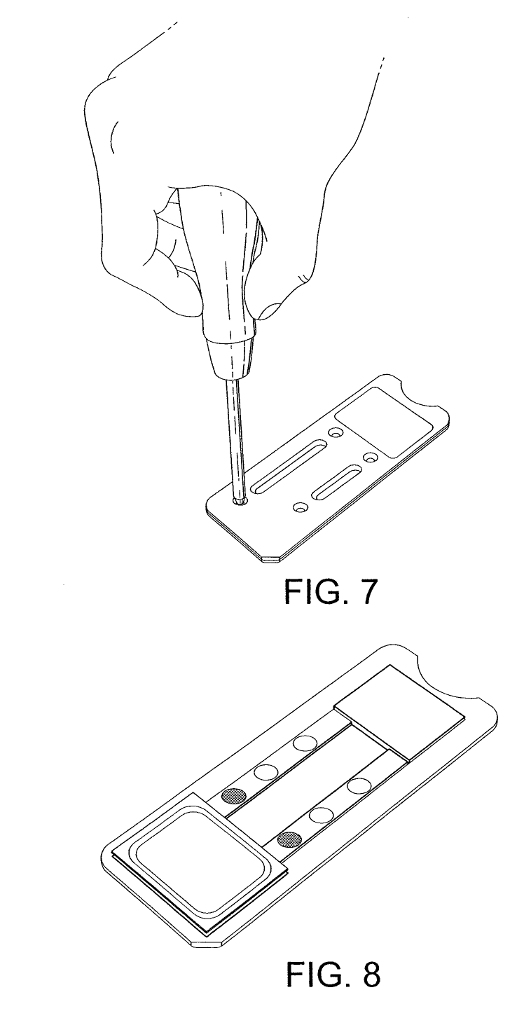

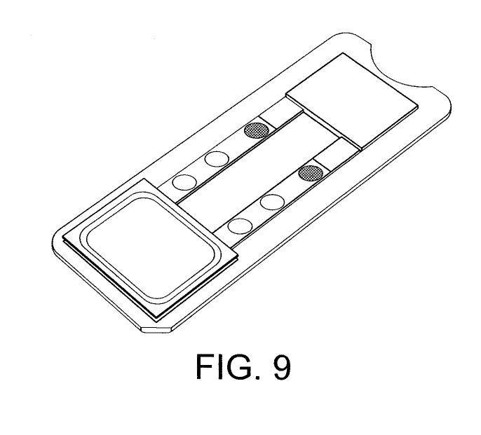

During the assay, a quantity of the analyte is dispensed into a dispensing port 20 that is located over one of the pathways above the application zone. The analyte may be dispensed by means of a pipette, dropper or other appropriate device in order to dispense a defined quantity of the analyte as shown in FIG. 7. A quantity of a control analyte may be applied to a dispensing port 21 located over the application zone of the other pathway 10. The control analyte may be one that exhibits a known strong bond with the label material and capture material, and a control label may be present (which may be the same or different to the label employed in the other pathway) in order to exhibit a strong, defined signal when the device is illuminated in order to enable the operator to confirm that analyte has been dispensed during the assay. In the case of a quantitative analysis, it is possible to use the signal generated from the control label as a reference against which the signal from the analyte/label signal may be compared. For example the control analyte/control label bond and control analyte/control capture material bond may be based on a biotin-avidin bond or a similar bond as mentioned above. Initially the analyte will wet the pathways located under the dispensing ports 20 and 21 as shown by the hatched regions in FIG. 8. The analyte will travel along the pathway by capillary action taking the label from the label zone 16 of FIG. 5 with it. At the capture zone 18 the analyte and label will bond to the pathway as shown by the hatched region in FIG. 9. Downstream of the capture zone 18 on the pathway or each of the pathways 10 is a process control zone 26 which is located below a process control window 28 in the top surface of the device. After application of analyte it will travel along the pathway by capillary action, and will hydrate the pathway causing a colour change. The pathway can be viewed through the process control windows 28 in order to observe the colour change and ensure that the analyte and label have travelled along the pathway to and beyond the capture zone 18.

A wash may then be applied to cause the analyte, control analyte and label to flow along the pathways toward the wash collection reservoir 12. The wash may be applied in any number of ways. For example it may be applied to sample dispensing port or an alternative port by means of a pipette, dropper or other device that will dispense a controlled quantity of wash into the dispensing ports 20 and 21. Alternatively, a wash dispensing reservoir 24 may be provided in the device at the end of the device opposite the wash collection reservoir, or on a side of the device. The dispensing reservoir may be in the form of a bladder, blister pack or sachet which may be punctured in order to cause the wash to flow along the pathways. In another form of arrangement where a reader is employed as described below, the reader may be designed to receive the assay device and be provided with a ridge or protuberance that will apply a stress to the wash dispensing reservoir and rupture it when the device is inserted into the reader so that the wash is applied automatically on insertion of the assay device into the reader.

Once the wash has been applied, substantially no material should be present on the pathway other than the analyte bound to the capture zone and the label that is bound to the analyte.

With many forms of capture and label arrangement the assay device may be ready to be illuminated and read as soon as the device is washed. However, in some cases a further processing step may be necessary in order to activate the label (which may be referred to herein at times as a label precursor). For example, where some forms of fluorescent label are used as described below, and in particular where fluorescein diacetate (FDA) is used, it may be necessary to hydrolyse the precursor and/or to heat it in order to release the label. This operation may be performed at any appropriate time. For example, if an acid or base hydrolysis step is necessary, the appropriate acid or base may be applied either before or after application of the analyte, for example along with the wash step. In this case, the wash in the wash reservoir may have a pH that will cause the hydrolysis so that the activation step occurs automatically with the washing step.

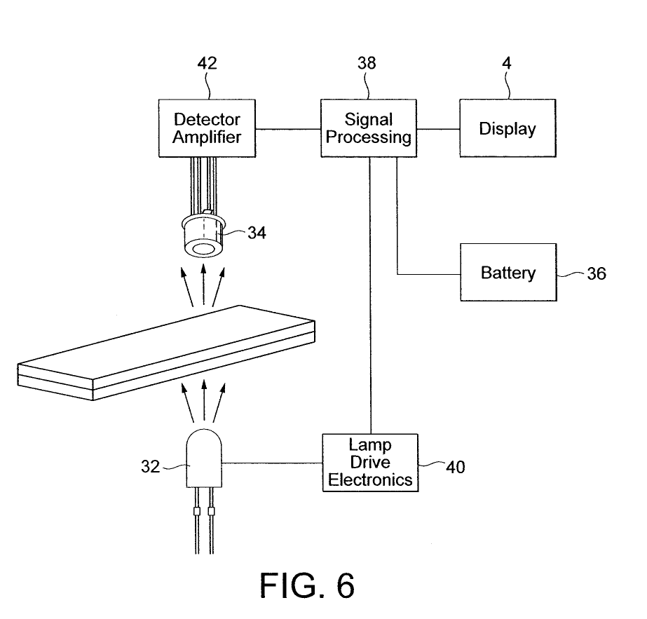

The assay device is now ready to be illuminated in order to detect the presence of analyte. This may be achieved by means of a reader as shown in FIGS. 1 and 6. The reader comprises a housing having a slot 30 therein for receiving the assay device 1, a light source 32 for example an LED or an incandescent lamp, located on one side of the slot for receiving the assay device, and an optical sensor for example a PIN diode or a avalanche photodiode located on the opposite side of the slot so that light from the light source will pass through the device. The light source may be powered by a standard battery 36 or other power source such as a transformer. The reader includes conventional signal processor for controlling light source drive electronics 40, a detector amplifier circuit 42 and a display circuit 44 for the display 4.

The assay device is preferably provided with a polarizing profile in order to ensure that the device cannot be inserted into the reader upside down or back to front. As will be appreciated, inserting the device upside down will cause any excitation wavelengths to be filtered out by the longer wavelength filter on the upper surface of the device. Such a polarizing profile may include a cut corner 29 which will cooperate with a corresponding corner in the reader. Also, a part-circular cut out 30 may be included in one end of the device to ensure which end of the device is inserted. Many other forms of polarizing profile may be employed.

In some cases, the assay device may be illuminated as soon as the pathways have been washed, but in other cases it may be necessary to wait for a period of time before illumination, in which case a timer may be provided in the reader in order to ensure that the device is illuminated and read at the appropriate time. For example, in the case of base hydrolysed FDA, it may be advantageous to wait for a period of from 100 to 500 seconds after hydrolysis before illumination.

Although the term “light” has been used herein, it will be appreciated that this is because the device is intended for reading visually. Any electromagnetic radiation may in principle be used to read the device, and the light will not necessarily be visible light, although this is preferred. The light may have components in the infrared or ultraviolet spectrum and may even have a spectrum in which the radiation is predominantly in wavelength ranges outside the visible wavelength range. However, as explained below, the light is preferably in the visible range.

The label material located in the device may be one that will emit or modify light, at least when activated, so that the light emitted from the device due to the presence of the analyte will differ from the illuminating light.

One surface of the device that receives the light only after it has passed through the label material, in this embodiment the top cover 8, is formed from a material that provides a first optical filter that will allow transmission of the light emitted or modified by the label material and will block light of at least one other wavelength range. This has the advantage that the effect of the label material is enhanced by removing at least some of the background light that is not affected by the label material.

Preferably the other surface of the device, that is to say the surface that will be illuminated by the light source during the reading stage, is also formed from a material that forms a second optical filter that has a different optical transmission characteristic from that of the first optical filter.

In the preferred form of device, the second optical filter will allow transmission of light of a shorter wavelength range than that of the first optical filter, for example the second optical filter may be a blue filter while the first optical filter may be a green filter. Especially the filters will be such that together they will block light in substantially the entire visible light range. In other words, in the preferred form of device, the long wavelength cutoff of the second filter will be substantially the same as, or in the region of the short wavelength cutoff of the first filter, so that the combination of the two filters will block substantially all visible light.

The filters provided in the top and bottom of the assay device may be formed from any appropriate material, for example glass, plastics materials, thin film materials or they may be holographic filters or interference filters. In an interference filter, a dielectric coating is deposited in layers to allow only the desired wavelengths to pass while light of other wavelengths is reflected. However, in view of the fact that the filters are provided on the assay device which will be a consumable item, the materials should be relatively inexpensive and so plastics filters are preferred.

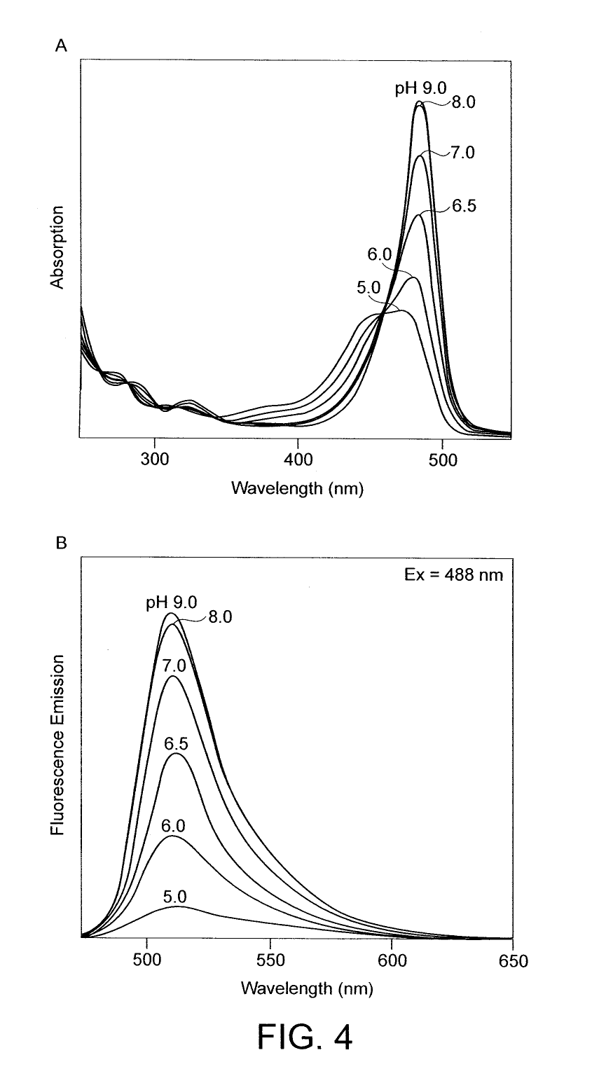

If the label material is one such as a fluorescent or phosphorescent material which exhibits a Stokes shift between its absorption spectrum and emission spectrum, it is possible for the filters formed by both surfaces of the device to block substantially all light but allow fluorescence or phosphorescence caused by the label to be detected. For example, FIG. 4 shows the absorption spectrum of fluorescein (graph A) which may be employed as a label material with a maximum at 492 nm and its emission spectrum (graph B) with a maximum at 517 nm. As can be seen the use of a second optical filter having a long wavelength cutoff in the region of 500 nm and a second optical filter having a short wavelength cutoff in the region of 500 nm will allow substantially the entire fluorescence from fluorecein to be observed against a dark background.

The use of labels that can affect the wavelength of light such as fluorescent or phosphorescent materials together with optical filters on both sides of the assay device as described above rather than being associated with the reader has the important advantage that it is possible, at least for a number of tests (for example many qualitative tests or where a high concentration of analyte is present) to dispense with the optical reader so that it is possible simply to hold the assay device up to a source of white light, for example the sun, and observe the presence or absence of any bands on the pathway caused by the fluorescent label.

According to the broadest aspect of the invention, any of a number of label materials may be employed in the device. These may include simple coloured dyes or pigments that will affect the absorption spectrum of the analyte, but they are preferably fluorescent, phosphorescent or chemiluminescent materials. Examples of materials that may be employed as labels are disclosed in U.S. Pat. No. 7,796,266, the disclosure of which is incorporated herein by reference. In addition, the term “label” as used herein can include precursors of a label where appropriate, so that some additional step or steps may be needed before the material functions as an optical label, for example acid or base hydrolysis may be required or the application of heat or both.

According to one preferred embodiment, the label material comprises a lipid walled capsules, optionally having a polymer outer shell, containing a signal precursor. For example, the capsules may be formed from the lipid DSPE-PEG2000 Amine and sodium dodecyl sulphate (SDS) and containing fluorescein diacetate (FDA) as the signal precursor. These capsules may be activated by being placed in an activation solution having a pH of approximately 10.1 which is just below the pH value at which the FDA in this type of capsule will undergo rapid hydrolysis to fluorescein without additional heat. Such forms of label material are disclosed in international patent application No. WO 02/12888 A2, the disclosure of which is incorporated herein by reference. These capsules may release very large amounts of fluorescein when activated, with the result that assays employing these capsules can be extremely sensitive since the intensity of the fluorescent light can be many orders of magnitude above that of other fluorescent or phosphorescent materials. Indeed it is conjectured that it is this very high degree of fluorescence generated by activation of the FDA capsules when activated that enables the FDA capsules to be employed in an assay device according to the present invention employing relatively cheap and low performance optical filters located on a consumable component such as the assay device. According to U.S. Pat. No. 7,796,266 referred to above, it is a large Stokes shift, for example from 100 nm to 350 nm, that minimizes the need for expensive, high precision filters in the optical detection in order to eliminate background interference. However fluorecein employed according to the present invention has a Stokes shift of only about 25 to 28 nm.

In fact, the use of fluorescent or phosphorescent labels, and especially labels formed from the FDA capsules referred to above, can have the effect that the assay device can exhibit an absorption spectrum of the fluorescein when exposed to white light. Thus, according to yet another aspect, the method according to the invention includes the step of illuminating the assay device from one side with white light and viewing the device from the other side in order to detect absorption bands in the pathway caused by absorption of light by the fluorescent label material. In this method it is not necessary to include any second optical filter on the side of the device that is illuminated although it may be advantageous to do so in order to reduce the intensity of light passing through the assay device that is not affected by the absorption by the fluorescent or phosphorescent material, and so increase the proportion of light that is absorbed by the fluorescent or phosphorescent material.

1. An assay device for enabling a test to be performed on an analyte, the device having an application zone for application of a quantity of the analyte, a waste zone, and a pathway for allowing passage of the analyte from the application zone to the waste zone, the device including a quantity of a label material which will emit or modify light at least when activated and which will bind to the analyte, the pathway also including a capture zone located between the application zone and the waste zone that has a quantity of capture material which is bound to the pathway and which will bind to analyte that passes along the pathway so that the analyte will be bound to the pathway, the device having a first optical filter on a side thereof for allowing transmission of light emitted or modified by the label material and for blocking light of at least one other wavelength range in order to enable the device to be illuminated from one side thereof and for light emitted or modified by the label material located in the pathway to be detected from the opposite side thereof.

2. A device as claimed in claim 1, which includes a second optical filter located on the side thereof that will be illuminated, which second filter has a different optical transmission characteristic from that of the first optical filter.

3. A device as claimed in claim 2, wherein the second optical filter will allow transmission of light of shorter wavelength than light transmitted by the first optical filter.

4. A device as claimed in claim 3, wherein the label material is a fluorescent or phosphorescent material or a precursor thereof, and the first optical filter will allow transmission of light only after modification by the label material.

5. A device as claimed in claim 1, wherein the first optical filter will allow transmission of light of different wavelengths that correspond to light emitted or modified by different label materials.

6. A device as claimed in claim 1, which includes a plurality of different filters that are located at different positions on the pathway.

7. A device as claimed in claim 1, which includes a plurality of pathways for passage of different analytes.

8. A device as claimed in claim 7, which includes a plurality of different filters for allowing transmission of light emitted or modified by the label material, each such filter being associated with a different pathway.

9. A device as claimed in claim 1, wherein the label material is held in a label zone that is located between the application zone and the capture zone.

10. A device as claimed in claim 1, which includes a process control zone located between the capture zone and the waste zone to enable visual inspection of the pathway at the process control zone in order to determine the extend of passage of the sample.

11. A device as claimed in claim 1, which includes a reservoir of a carrier for enabling the sample to pass along the pathway to the waste zone.

12. A device as claimed in claim 11, wherein the reservoir is manually rupturable.

13. A device as claimed in claim 12, wherein the reservoir is in the form of a bladder, blister pack or sachet.

14. A device as claimed in claim 1, which includes an additional pathway for receiving a control sample and allowing the control sample to pass to the capture zone.

15. A device as claimed in claim 1, which includes a plurality of pathways extending generally in parallel with one another from an application zone to a waste zone, the pathways containing different capture materials to enable a test to be performed on a plurality of different samples.

16. A device as claimed in claim 1, which is arranged for enabling a lateral flow or microfluidic test to be performed on the analyte.

17. An arrangement for performing an assay, which comprises a device as claimed in claim 1 and a reader for detecting an output from the device, which comprises a body having an orifice that is capable of receiving the assay device, a light source for illuminating the device from one side thereof once it has been received in the reader, a terminal for receiving a power source for the light source, an optical detector located in the body on the opposite side of the orifice for detecting light that has been emitted by the device, and a detector for detecting the optical power of light detected by the optical detector.

18. An arrangement as claimed in claim 17, wherein the reader includes a display for displaying data defining the optical power of light detected by the optical detector or relating to absorption of light by material in the device.

19. An arrangement as claimed in claim 17, wherein the reader includes a protuberance that will cause a stress to be applied to part of the device when the device is inserted into the slot.

20. An arrangement as claimed in claim 17, which includes a plurality of optical detectors for detecting light from the light source that has passed through a cartridge inserted in the slot, the optical detectors being located at different positions in the body of the reader.

21. A method of performing a test on an analyte, by means of an assay device having an application zone for application of the analyte, a waste zone, and a pathway for allowing passage of the analyte from the application zone to the waste zone, the pathway also including a capture zone located between the application zone and the waste zone that has a quantity of capture material which is bound to the pathway and which will bind to any analyte, which method comprises:
applying a quantity of the analyte to the application zone and allowing the analyte to pass along the pathway to and beyond a capture zone where the pathway includes a quantity of capture material which will bind the analyte to the pathway,
causing the analyte to contact a quantity of a label material (either before or after it has reached the capture zone) which will emit or modify light at least when activated and which will bind to the analyte so that the analyte and label material will be bound to the pathway at the capture zone;
applying a quantity of a wash to the application zone in order to cause excess analyte and label material to flow along the pathway to the waste zone; and
illuminating one side of the assay device and detecting light that is emitted or modified by the label material from the opposite side of the device, the said opposite side of the device including an optical filter for allowing transmission of light emitted or modified by the label material and for blocking light of at least one other wavelength so that detection of the light will indicate the presence or quantity of the analyte.

22. A method as claimed in claim 21, wherein the assay device includes the label material before commencement of the method.

23. A method as claimed in claim 22, wherein the label material has been provided during manufacture of the assay device.

24. A method as claimed in claim 21, wherein the pathway includes the label material in a zone between the application zone and the capture zone so that the label material will be associated with the label material as it passes along the pathway to the capture zone.

25. A method as claimed in claim 21 which includes the step of applying a quantity of the label material to the device.

26. A method as claimed in claim 21, which is a lateral flow or microfluidic test.

27. A method as claimed in claim 21, which comprises inserting the device into a reader for detecting an output from the device, the reader comprising a body having a slot that is capable of receiving the assay device, a light source for illuminating the device from one side thereof once it has been received in the reader, an optical detector located in the body on the opposite side of the slot for detecting light that has been emitted by the device, and an arrangement for detecting the optical power of light detected by the optical detector.

28. A method as claimed in claim 21, which comprises illuminating the device with white light on one surface thereof and observing the opposite surface to determine the presence or quantity of analyte from the label material.

29. A method as claimed in claim 28, wherein the label material comprises a fluorescent or phosphorescent material.

30. A method as claimed in claim 28, which comprises determining positions on the pathway where light has been absorbed by the label material.
